(19) United States
(12) Patent Application Publication
(10) Pub. No.: US 2011/0187550 A1
(43) Pub. Date: Aug. 4, 2011

(54) DISPLAY DEVICE

(75) Inventor: Joffrey Ringenwald, Strasbourg (FR)

(73) Assignee: Johnson Controls GmbH

(21) Appl. No.: 13/055,452

(22) PCT Filed: Jul. 22, 2009
(86) PCT No.: PCT/DE2009/001021

§ 371 Date: Apr. 15, 2011

(30) Foreign Application Priority Data
Jul. 22, 2008 (DE) 102008034276.9

(51) Int. Cl. G08B 5/00; G01D 13/00

(52) U.S. Cl. 340/815.4; 116/284

(57) ABSTRACT

The invention relates to a display device for emission parameters of an internal combustion engine with a linear representation of a value range, wherein a first and a second part region are provided for the display of difference values with differing sign relative to a given set value.

The invention relates to a display device for emission parameters of an internal combustion engine and having a linearly displayed value range.

### PRIOR ART

A generic device is disclosed in laid-open specification DE 34 09 948 A1. In this case, the measurement values of a probe integrated in the exhaust system of a motor vehicle are reproduced by a display instrument that can be designed as an analog instrument in the form of a pointer display in front of a scale. An acoustic or optical signal is also possible, the result being to alert the vehicle driver to the transgression of a threshold value and to request that a workshop be found. The primary aim of this device is therefore information relating to deteriorated operating conditions that is based on a current display of state.

### OBJECT

The object of the invention is to support the vehicle driver more effectively in providing a driving style that is as low in emissions as possible.

### Solution

The object is achieved according to the invention by virtue of the fact that the generic device for displaying difference values is developed with reference to a preset value, it being possible to undershoot the preset value. The result of this is that the vehicle driver experiences a positive reinforcement in his concern for a driving style that is as low in emissions as possible. By way of example, the preset value can be the manufacturer's indication of the average exhaust gas level of the respective vehicle type. Given undershooting of the preset value, a difference value is then displayed that is located in a negative subrange of the value range—for example by displaying a percentage to the extent of which the preset value is undershot.

In order to permit a quick reading off operation, the preset value is provided as a fixed marker that advantageously corresponds to the uppermost position on a line implemented as a circle segment, in accordance with the way the display of a value range is customarily encountered with pointer instruments used in automobile construction.

The difference value is displayed by a movable marker that is formed in terms of one embodiment by the tip of a pointer. This pointer can be implemented as a real component or as an image on a graphic display.

In a further embodiment, the movable marker is formed by an individual element or the interaction of a plurality of juxtaposed elements where optical properties are varied in order to effect the display function such as, for example, illuminated LEDs or LEDs undergoing a change of color, backlit LCD segments, in individual display, as a bar graph etc.

In one embodiment of the inventive device, the value range is provided with scaling, it thereby being possible to numerically establish the difference value displayed. The scaling can be fixed during production of the device, or be designed in an alterable fashion; the first variant is more cost effective, while in the second variant it is possible to alternate between various types of display, for example a percentage deviation from the preset value and an absolute specification of the difference value (for example: minimum output in −n grams CO₂ per kilometer).

It is likewise possible not to provide scaling on principle, or not to provide it for display in one operating mode of the display device.

Scaling need not necessarily be provided proportionally, but can be implemented non-proportionally in a stepwise or sliding fashion. This depends on the desired operating behavior of the display device, and likewise on the type of the preset value. It is also possible for different scaling to be used in each case for the positive and negative subranges of the value range.

### FIGURES

The figures illustrate various designs of the invention in exemplary and schematic fashion. In the drawing:

FIG. 1 shows a device according to a first design of the invention, in the case of which a mixed form of two types of scaling is shown for the value range,

FIG. 2 shows an embodiment with a bar graph instead of a pointer for the movable marker, and

FIG. 3 shows an embodiment without scaling in the case of which the illustration of the value range and the display of the movable marker are effected by the same elements.

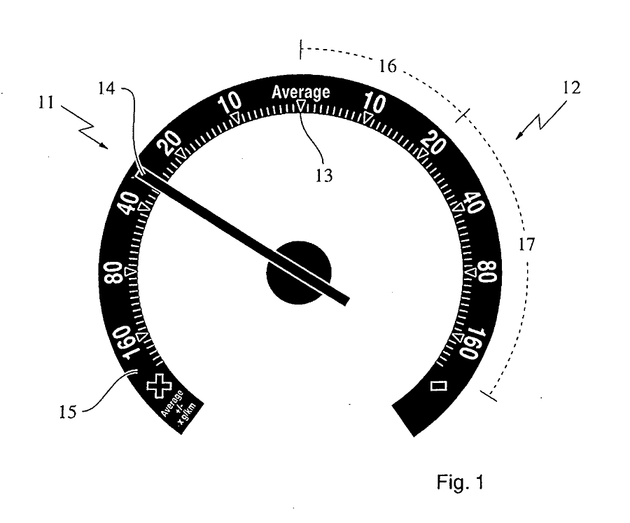

In the device depicted in FIG. 1, the scaling 15 is set up to illustrate absolute values (in g/km). It comprises a first subrange 11 and a second subrange 12 —which are designed to be the same size in the present case—for displaying positive and negative values respectively. At a dividing point between these subranges, the preset value 13 is characterized as an average value (average) and arranged at the uppermost position of the circle segment.

The scaling is subdivided into a first zone 16 with a proportional profile, and a second zone 17 with a non-proportional profile, the result being a mixed form for the scaling overall.

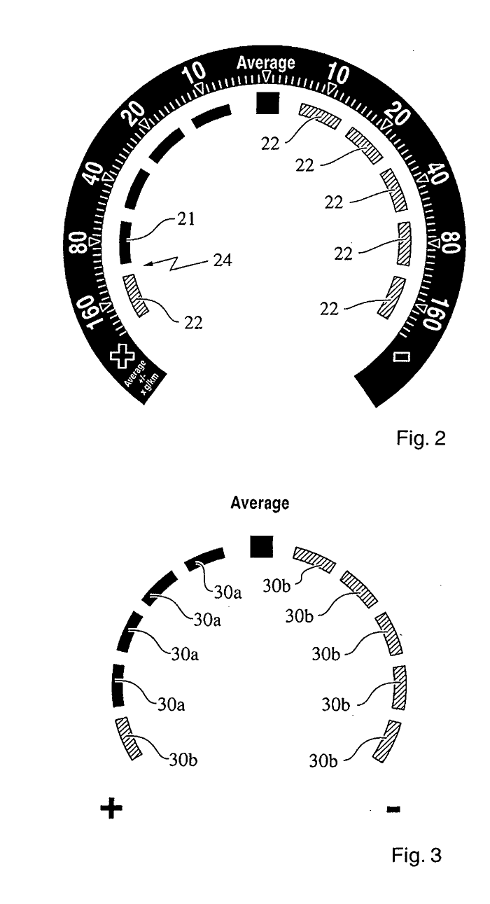

In the embodiment according to FIG. 2, the difference value is displayed by a bar graph that starts from the preset value and extends over approximately 95° in a counterclockwise direction and whose end zone 24 forms the movable marker by virtue of the fact that the corresponding element 21 is the last one in a row of a plurality of neighboring, light-emitting LEDs. The hatched elements 22 are also illustrated here by way of explanation, but are not visible in this embodiment in the state shown, for lack of output light.

The embodiment according to FIG. 3 combines the display of value range and difference value with the use of the same elements, specifically by means of color change. A bar graph shown in FIG. 2 is displayed by virtue of the fact that the color of the elements 30a forming it is different from the remaining elements 30b that are visible in each operating state in this design. Here, as well, the preset value is arranged at the same location as in the other embodiments. Plus and minus symbols are retained in order to distinguish the first subrange from the second one. No scaling is present in this embodiment, apart from the implicit grading owing to the multiplicity of the elements 30.

### REFERENCE NUMERALS

11 First subrange
12 Second subrange
13 Preset value
14 Movable marker
15 Scaling
16 First zone of the scaling
17 Second zone of the scaling
21 LED, emitting
22 LED, inactive
24 Movable marker
30a Element with color effect
30b Element with other color effect

1. A display device for emission parameters of an internal combustion engine, comprising:
a line providing a linearly displayed value range;
a marker that is movable along the line; and
a marker that is fixed along the line,
wherein the value range comprises a first subrange for displaying positive values and a second subrange for displaying negative values.

2. The display device as claimed in claim 1, characterized in that the movable marker is formed by the tip of a pointer that is physically present or embodied as a graphic symbol.

3. The display device as claimed in claim 1, wherein the movable marker is embodied by influencing an optical property of one or more neighboring elements that are provided in a fashion fixed along the value range line.

4. The display device as claimed in claim 1, wherein the fixed marker is arranged at the division point between the subranges of the value range.

5. The display device as claimed in claim 1, wherein the value range has scaling.

6. The display device as claimed in claim 5, the scaling is implemented either proportionally or non-proportionally or as a mixed form composed of these two possibilities.

7. The display device as claimed in claim 5, wherein the scaling is designed in a way that can be altered.

8. The display device as claimed in claim 6, wherein the scaling is designed in a way that can be altered.
